(19) United States
(12) Patent Application Publication
(10) Pub. No.: US 2020/0147718 A1
(43) Pub. Date: May 14, 2020

(54) LIQUID COOLING JACKET MANUFACTURING METHOD

(71) Applicant: NIPPON LIGHT METAL COMPANY, LTD., Tokyo (JP)

(72) Inventors: Hisashi HORI, Shizuoka (JP); Nobushiro SEO, Shizuoka (JP)

(73) Assignee: NIPPON LIGHT METAL COMPANY, LTD., Tokyo (JP)

(21) Appl. No.: 16/615,777

(22) PCT Filed: Nov. 20, 2017
(86) PCT No.: PCT/JP2017/041707

§ 371 Date: Nov. 21, 2019

(30) Foreign Application Priority Data
Aug. 22, 2017 (JP) 2017-159143

(51) Int. Cl. B23K 20/12

(52) U.S. Cl. CPC B23K 20/1225; B23K 2103/10

(57) ABSTRACT

The present invention includes a preparation step in which a stepped portion including step bottom and step side surfaces is formed along an edge of a jacket body, a placing step in which a sealing body is placed on the jacket body forming first and second butted sections, and a main joining step in which friction stir welding (FSW) is performed by moving a rotary tool along the first butted section with only a stirring pin of the rotary tool in contact with only the sealing body. During FSW, a central axis of rotation of the rotary tool is tilted towards a central or peripheral side of the jacket body so that the angle of tilt relative to a vertical plane equals the angle the stirring pin's outer circumferential surface makes with the central axis of rotation subtracted by the angle the step side surface makes with a vertical plane.

### TECHNICAL FIELD

The present invention relates to a method for manufacturing a liquid-cooling jacket.

### BACKGROUND ART

An example of a manufacturing method for a liquid-cooling jacket is disclosed in Patent Literature 1. FIG. 12 shows a cross-sectional view illustrating a conventional manufacturing method for a liquid-cooling jacket. In the conventional manufacturing method for a liquid-cooling jacket, friction stir welding (FSW) is used on a butted section J10 formed by butting the side surface 102c of an aluminum alloy sealing body 102 and the step side surface 101c provided on the stepped portion of an aluminum alloy jacket body 101. Further, in the conventional manufacturing method for a liquid-cooling jacket, friction stir welding is carried out by inserting only the stirring pin F2 of a rotary tool F into the butted section J10. Yet further, the conventional manufacturing method for a liquid-cooling jacket moves the rotary tool F along the butted section J10 so that the central axis of rotation C overlaps with the butted section J10.

### CITATION LIST

### Patent Literature

Patent literature 1: Japanese Unexamined Patent Application Publication No. 2015-131321

### SUMMARY OF THE INVENTION

### Technical Problem

A jacket body 101 can often become complex in shape, leading to cases where, say, a 4000-series cast aluminum alloy is used to form the jacket body 101 and a 1000-series wrought aluminum alloy is used for a relatively simple shaped sealing body 102. In this way, the manufacture of a liquid-cooling jacket can include the joining of members of different aluminum alloy materials. Generally, in such cases, the jacket body 101 becomes harder than the sealing body 102, and if friction stir welding is carried out as shown in FIG. 12, material resistance on the side of the jacket body 101 becomes greater than material resistance on the side of the sealing body 102 for the stirring pin F2. This makes it difficult to stir different types of materials in a well balanced manner, causing void defects to be left behind in the plasticized region from the joining process, resulting in the reduction in joining strength. Further, because the stirring pin F2 of the rotary tool F has an inclined outer circumferential surface, if the rotary tool F is inserted into the butted section J10 so that the central axis of rotation C of the rotary tool F is upright relative to the butted section J10, it becomes difficult to produce a uniform joint across the step side surface 101c of the jacket body 101.

In view of the above, it is an object of the present invention to provide a manufacturing method for a liquid-cooling jacket that is suitable for joining different types of aluminum alloys.

### Solution to Problem

In order to solve the problems described above, a first invention provides a method for manufacturing a liquid-cooling jacket that is composed of a jacket body, having a bottom portion and a peripheral wall portion that is provided to stand on the periphery of the bottom portion, and a sealing body, which seals an opening of the jacket body, wherein the jacket body and the sealing body are joined using a rotary tool with a stirring pin, the method including: a preparation step which forms, along an inner circumferential edge of the peripheral wall portion, a stepped portion having a step bottom surface and a step side surface rising and sloping backwards from the step bottom surface to the opening of the jacket body; a placing step where the sealing body is placed on the jacket body to allow the step side surface and a sealing body side surface to butt each other to form a first butted section and a part of a sealing body back surface to be overlaid on the step bottom surface to form a second butted section; and a main joining step where friction stir welding is performed by moving the rotary tool once around the sealing body along the first butted section while only the stirring pin of the rotating rotary tool is in contact with only the sealing body, wherein the jacket body is formed from a first aluminum alloy and the sealing body is formed from a second aluminum alloy, the first aluminum alloy is a harder type of material than the second aluminum alloy, the stirring pin has an inclined outer circumferential surface that tapers down, and during the main joining step, a central axis of rotation of the rotary tool is tilted either towards a central side or peripheral side of the jacket body, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

According to this manufacturing method, frictional heat generated between the sealing body and the stirring pin causes material at the first butted section, primarily the second aluminum alloy of the sealing-body, to be stirred, plasticized, and fluidized, enabling the step side surface and the side surface of the sealing body to be joined at the first butted section. Also, because friction stirring is performed with only the stirring pin in contact with only the sealing body, there is hardly any transfer of the first aluminum alloy from the jacket body to the sealing body. In this way, friction stirring at the first butted section occurs primarily in the second aluminum alloy on the sealing body side, making it possible to suppress the reduction in joining strength. Also, because the central axis of rotation of the rotary tool is tilted either towards the central side or peripheral side of the jacket body by a tilt angle γ relative to a vertical plane, contact between the stirring pin and the jacket body can be avoided with ease. Also, γ, the tilt angle of the central axis of rotation of the rotary tool relative to a vertical plane, is made equal to α−β, where α is the inclination angle of the outer circumferential surface of the stirring pin relative to the central axis of rotation and β is the inclination angle of the step side surface relative to a vertical plane. This way, it becomes possible to select optimum values for the inclination angles α and β. Also, by keeping the step side surface and the outer circumferential surface of the stirring pin facing the step side surface parallel to each other, it becomes possible to bring the outer circumferential surface of the stirring pin and the step side surface as close as possible to each other along the height direction while avoiding contact.

Further, a second invention provides a method for manufacturing a liquid-cooling jacket that is composed of a jacket body, having a bottom portion and a peripheral wall portion provided to stand on the periphery of the bottom portion, and a sealing body, which seals an opening of the jacket body, wherein the jacket body and the sealing body are joined using a rotary tool with a stirring pin, the method including: a preparation step which forms, along an inner circumferential edge of the peripheral wall portion, a stepped portion having a step bottom surface and a step side surface rising and sloping backwards from the step bottom surface to the opening of the jacket body; a placing step where the sealing body is placed on the jacket body to allow the step side surface and a sealing body side surface to butt each other to form a first butted section and a part of a sealing body back surface to be overlaid on the step bottom surface to form a second butted section; and a main joining step where friction stir welding is performed by moving the rotary tool once around the sealing body along the first butted section while only the stirring pin of the rotating rotary tool is made to be in contact with the sealing body and only the stirring pin is made to be in slight contact with the step side surface of the jacket body, wherein the jacket body is formed from a first aluminum alloy and the sealing body is formed from a second aluminum alloy, the first aluminum alloy is a harder type of material than the second aluminum alloy, the stirring pin has an inclined outer circumferential surface that tapers down, and during the main joining step, a central axis of rotation of the rotary tool is tilted either towards a central side or peripheral side of the jacket body, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

According to this manufacturing method, because contact between the outer circumferential surface of the stirring pin and the step side surface of the jacket body is kept small, transfer of the first aluminum alloy from the jacket body to the sealing body can be kept as small as possible. In this way, friction stirring at the first butted section occurs primarily in the second aluminum alloy on the sealing body side, making it possible to suppress the reduction in joining strength. Also, because contact between the outer circumferential surface of the stirring pin and the step side surface of the jacket body is kept small, material resistance the stirring pin receives from the jacket body can be kept as small as possible. Also, γ, the tilt angle of the central axis of rotation of the rotary tool relative to a vertical plane, is made equal to α−β, where α is the inclination angle of the outer circumferential surface of the stirring pin relative to the central axis of rotation and β is the inclination angle of the step side surface relative to a vertical plane. This way, it becomes possible to select optimum values for the inclination angles α and β. Also, by keeping the step side surface and the outer circumferential surface of the stirring pin facing the step side surface parallel to each other, it becomes possible to make the contact margin between the outer circumferential surface of the stirring pin and the step side surface uniform along the height direction.

Yet further, a third invention provides a method for manufacturing a liquid-cooling jacket that is composed of a jacket body, having a bottom portion and a peripheral wall portion provided to stand on the periphery of the bottom portion, and a sealing body, which seals an opening of the jacket body, wherein the jacket body and the sealing body are joined using a rotary tool with a stirring pin, the method including: a preparation step which forms, along an inner circumferential edge of the peripheral wall portion, a stepped portion having a step bottom surface and a step side surface rising and sloping backwards from the step bottom surface to the opening of the jacket body; a placing step where the sealing body is placed on the jacket body to allow the step side surface and a sealing body side surface to butt each other to form a first butted section and a part of a sealing body back surface to be overlaid on the step bottom surface to form a second butted section; and a main joining step, wherein the jacket body is formed from a first aluminum alloy and the sealing body is formed from a second aluminum alloy, the first aluminum alloy is a harder type of material than the second aluminum alloy, the stirring pin has a flat tip surface and an inclined outer circumferential surface that tapers down, during the main joining step, friction stir welding is performed by moving the rotary tool once around the sealing body along the first butted section while a tip of the stirring pin of the rotating rotary tool is inserted below the step bottom surface and the outer circumferential surface of the stirring pin and the step side surface are kept apart, and during the main joining step, a central axis of rotation of the rotary tool is tilted either towards a central side or peripheral side of the jacket body, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

According to this manufacturing method, frictional heat generated between the sealing body and the stirring pin causes material at the first butted section, primarily the second aluminum alloy of the sealing-body, to be stirred, plasticized, and fluidized, enabling the step side surface and the side surface of the sealing body to be joined at the first butted section. Also, because friction stirring is performed at the first butted section with only the stirring pin in contact with only the sealing body, there is hardly any transfer of the first aluminum alloy from the jacket body to the sealing body. In this way, friction stirring at the first butted section occurs primarily in the second aluminum alloy on the sealing body side, making it possible to suppress the reduction in joining strength. Also, because the central axis of rotation of the rotary tool is tilted either towards the central side or peripheral side of the jacket body by a tilt angle γ relative to a vertical plane, contact between the stirring pin and the jacket body can be avoided with ease. Also, γ, the tilt angle of the central axis of rotation of the rotary tool relative to a vertical plane, is made equal to α−β, where α is the inclination angle of the outer circumferential surface of the stirring pin relative to the central axis of rotation and β is the inclination angle of the step side surface relative to a vertical plane. This way, it becomes possible to select optimum values for the inclination angles α and β. Also, by keeping the step side surface and the outer circumferential surface of the stirring pin facing the step side surface parallel to each other, it becomes possible to bring the outer circumferential surface of the stirring pin and the step side surface as close as possible to each other along the height direction while avoiding contact. Also, by inserting the tip surface of the stirring pin below the step bottom surface, the second butted section can be friction stirred more reliably.

Yet further, a fourth invention provides a method for manufacturing a liquid-cooling jacket that is composed of a jacket body, having a bottom portion and a peripheral wall portion provided to stand on the periphery of the bottom portion, and a sealing body, which seals an opening of the jacket body, wherein the jacket body and the sealing body are joined using a rotary tool with a stirring pin, the method including: a preparation step which forms, along an inner circumferential edge of the peripheral wall portion, a stepped portion having a step bottom surface and a step side surface rising and sloping backwards from the step bottom surface to the opening of the jacket body; a placing step where the sealing body is placed on the jacket body to allow the step side surface and a sealing body side surface to butt each other to form a first butted section and a part of a sealing body back surface to be overlaid on the step bottom surface to form a second butted section; and a main joining step, wherein the jacket body is formed from a first aluminum alloy and the sealing body is formed from a second aluminum alloy, the first aluminum alloy is a harder type of material than the second aluminum alloy, the stirring pin has a flat tip surface and an inclined outer circumferential surface that tapers down, during the main joining step, friction stir welding is performed by moving the rotary tool once around the sealing body along the first butted section while a tip of the stirring pin of the rotating rotary tool is inserted below the step bottom surface and the outer circumferential surface of the stirring pin is made to be in slight contact with the step side surface, and during the main joining step, a central axis of rotation of the rotary tool is tilted either towards a central side or peripheral side of the jacket body, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

According to this manufacturing method, because contact between the outer circumferential surface of the stirring pin and the step side surface of the jacket body is kept small, transfer of the first aluminum alloy from the jacket body to the sealing body can be kept as small as possible. In this way, friction stirring at the first butted section occurs primarily in the second aluminum alloy on the sealing body side, making it possible to suppress the reduction in joining strength. Also, because contact between the outer circumferential surface of the stirring pin and the step side surface of the jacket body is kept small, material resistance the stirring pin receives from the jacket body can be kept as small as possible. Also, γ, the tilt angle of the central axis of rotation of the rotary tool relative to a vertical plane, is made equal to α−β, where α is the inclination angle of the outer circumferential surface of the stirring pin relative to the central axis of rotation and β is the inclination angle of the step side surface relative to a vertical plane. This way, it becomes possible to select optimum values for the inclination angles α and β. Also, by keeping the step side surface and the outer circumferential surface of the stirring pin facing the step side surface parallel to each other, it becomes possible to make the contact margin between the outer circumferential surface of the stirring pin and the step side surface uniform along the height direction. Also, by inserting the tip surface of the stirring pin below the step bottom surface, the second butted section can be friction stirred more reliably.

Further, it is preferable to make the plate thickness of the sealing body greater than the height of the step side surface. By doing so, it becomes possible to supplement metal that is deficient at the joint with ease.

Yet further, it is preferable to form a sloped surface on the side surface of the sealing body so that, in the placing step, surface contact is made between the sloped surface and the step side surface. This way, it becomes possible to supplement metal that is deficient at the joint with ease.

Yet further, it is preferable to form the sealing body from a wrought aluminum alloy and to form the jacket body from a cast aluminum alloy.

Yet further, it is preferable to rotate the rotary tool clockwise when a spiral groove is engraved on an outer circumferential surface of the rotary tool so that the spiral groove runs in a counterclockwise direction starting from a base end to a tip of the rotary tool, and to rotate the rotary tool counterclockwise when a spiral groove is engraved on the outer circumferential surface of the rotary tool so that the spiral groove runs in a clockwise direction starting from a base end to a tip of the rotary tool. This way, the plasticized and fluidized metal is led by the spiral groove to the tip side of the stirring pin, thereby reducing burring.

Yet further, in the main joining step, it is preferable to set the direction of rotation and direction of forward movement of the rotary tool so that, within a plasticized region formed along a movement locus of the rotary tool, the jacket body side becomes the shear side and the sealing body side becomes the flow side. This way, the jacket body side becomes the shear side, the stirring effect of the stirring pin around the first butted section is heightened, a rise in temperature of the first butted section can be expected, making it possible to more reliably join the step side surface with the side surface of the sealing body at the first butted section.

### Advantageous Effects of the Invention

With the method for manufacturing a liquid-cooling jacket according to the present invention, a suitable joining of different types of aluminum alloys can be achieved.

### BRIEF DESCRIPTION OF THE DRAWINGS

FIG. 1 is a perspective view showing a preparation step of a manufacturing method for a liquid-cooling jacket according to a first embodiment of the present invention.

FIG. 2 is a cross-sectional view showing a placing step of a manufacturing method for a liquid-cooling jacket according to a first embodiment.

FIG. 3 is a perspective view showing a main joining step of a manufacturing method for a liquid-cooling jacket according to a first embodiment.

FIG. 4 is a cross-sectional view showing a main joining step of a manufacturing method for a liquid-cooling jacket according to a first embodiment.

FIG. 5 is a cross-sectional view showing a liquid-cooling jacket subsequent to a main joining step of a manufacturing method for a liquid-cooling jacket according to a first embodiment.

FIG. 6 is a cross-sectional view showing a placing step of a manufacturing method for a liquid-cooling jacket according to a first modification of a first embodiment.

FIG. 7 is a cross-sectional view showing a placing step of a manufacturing method for a liquid-cooling jacket according to a second modification of a first embodiment.

FIG. 8 is a cross-sectional view showing a main joining step of a manufacturing method for a liquid-cooling jacket according to a second embodiment.

FIG. 9 is a cross-sectional view showing a main joining step of a manufacturing method for a liquid-cooling jacket according to a third embodiment of the present invention.

FIG. 10 is a cross-sectional view showing a main joining step of a manufacturing method for a liquid-cooling jacket according to a fourth embodiment of the present invention.

FIG. 11 is a cross-sectional view showing a main joining step of a manufacturing method for a liquid-cooling jacket according to a third modification of a third embodiment.

FIG. 12 is a cross-sectional view showing a conventional manufacturing method for a liquid-cooling jacket.

### DESCRIPTION OF EMBODIMENTS

### First Embodiment

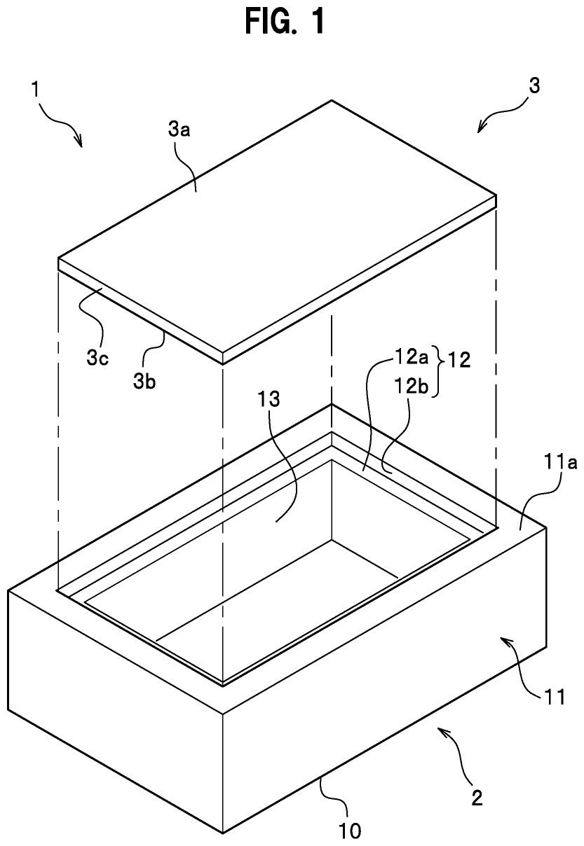

A manufacturing method for a liquid-cooling jacket according to an embodiment of the present invention will be described in detail with reference to drawings. As shown in FIG. 1, the manufacturing method for a liquid-cooling jacket 1 according to an embodiment of the present invention includes manufacturing a liquid-cooling jacket 1 by using friction stir welding to join a jacket body 2 and a sealing body 3. The liquid-cooling jacket 1 is a member for placing a heat-generating element (not shown in figure) on the sealing body 3 and exchanging heat with the heat-generating element by circulating fluid inside. In the description that follows, the term “front surface” is used to refer to the side opposite to the “back surface”.

The manufacturing method for a liquid-cooling jacket according to the present embodiment includes carrying out a preparation step, a placing step, and a main joining step. The preparation step includes preparing the jacket body 2 and the sealing body 3. The jacket body 2 is composed primarily of a bottom portion 10 and a peripheral wall portion 11. The jacket body 2 is formed mainly from a first aluminum alloy. The first aluminum alloy uses, say, a cast aluminum alloy such as JIS H5302 Grade ADC12 (Al—Si—Cu).

As shown in FIG. 1, the bottom portion 10 is a plate-type member that is rectangularly shaped in planar view. The peripheral wall portion 11 is a wall portion that stands on the periphery of the bottom portion 10 to form a rectangular frame. A stepped portion 12 is formed along the inner circumferential edge of the peripheral wall portion 11. The stepped portion 12 includes a step bottom surface 12a and a step side surface 12b that rises from the step bottom surface 12a. As shown in FIG. 2, the step side surface 12b rises and slopes backwards from the step bottom surface 12a towards an opening of the jacket body 2. The angle of inclination of the step side surface 12b with respect to a vertical plane, β, can be set as appropriate, and is, for example, set between 3° and 30°. The bottom portion 10 and the peripheral wall portion 11 form a recess 13. Here, a vertical plane is defined as a plane configured from a vector describing the direction of travel of the rotary tool F and a vertical vector.

The sealing body 3 is a plate-type member that seals the opening of the jacket body 2. The sealing body 3 is suitably sized to be placed on the stepped portion 12. The plate thickness of the sealing body 3 is substantially the same as the height of the step side surface 12b. The sealing body 3 is formed primarily from a second aluminum alloy. The second aluminum alloy is a material that is less hard than the first aluminum alloy. The second aluminum alloy is formed from a wrought aluminum alloy such as JIS A1050, A1100, and A6063.

As shown in FIG. 2, the placing step includes placing the sealing body 3 on the jacket body 2. In the placing step, the back surface 3b of the sealing body 3 is placed on the step bottom surface 12a. The step side surface 12b and the side surface 3c of the sealing body 3 are butted together to form a first butted section J1. The first butted section J1 can include cases where surface contact is made between the step side surface 12b and the side surface 3c of the sealing body 3 and where butting leaves a gap having a substantially V-shaped cross section as in the present embodiment. Also, the step bottom surface 12a and the back surface 3b of the sealing body 3 butt each other to form a second butted section J2. In the present embodiment, the end surface 11a of the peripheral wall portion 11 and the front surface 3a of the sealing body 3 are flush with each other when the sealing body 3 is placed on the jacket body 2.

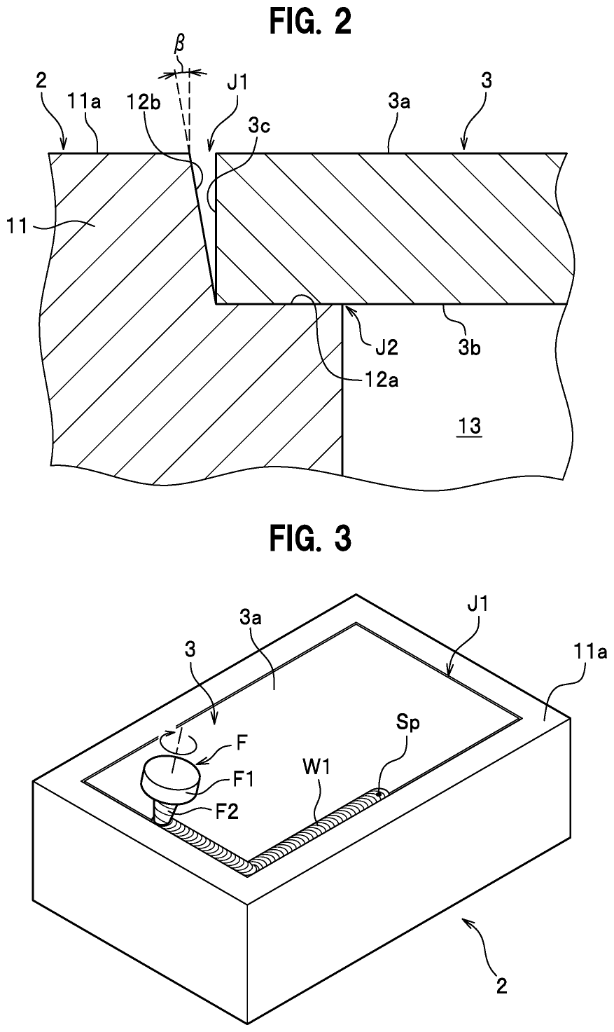

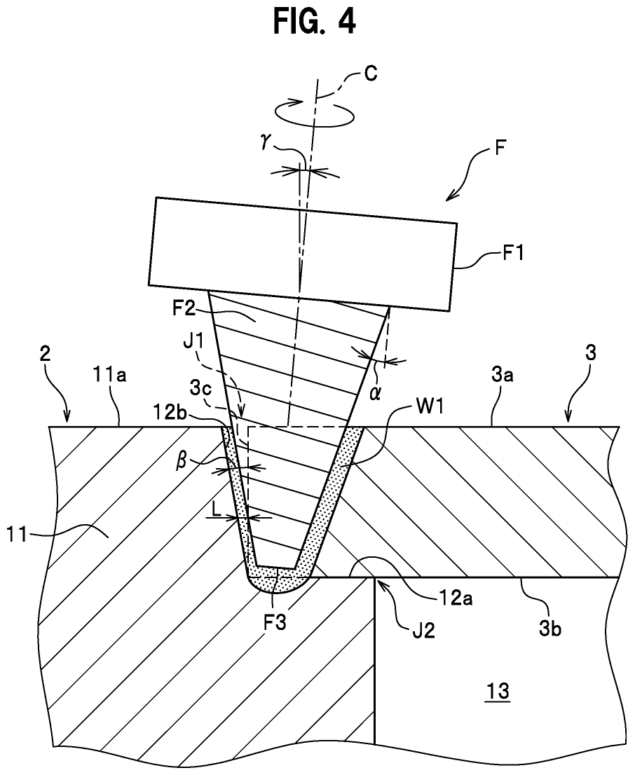

As shown in FIGS. 3 and 4, the main joining step includes using friction stir welding to join the jacket body 2 and the sealing body 3 with the use of a rotary tool F. The rotary tool F includes a connection portion F1 and a stirring pin F2. The rotary tool F is formed from, say, a tool steel. The connection portion F1 is a portion that connects to a rotary shaft of a friction stirring apparatus (not shown in figure). The connection portion F1 is cylindrical in shape, and has bolt holes (not shown in figure) formed therein to which bolts are fastened. The friction stirring apparatus onto which the rotary tool F is connected is, say, a robot arm equipped at the tip thereof with a rotary drive unit such as a spindle unit, and is capable of freely tilting the central axis of rotation C of the rotary tool F.

The stirring pin F2 hangs down from the connection portion F1, and is coaxial with the connection portion F1. The stirring pin F2 tapers off away from the connection portion F1. As shown in FIG. 4, a flat tip surface F3, whose surface is orthogonal to the central axis of rotation C, is formed at the tip of the stirring pin F2. In other words, the outer surface of the stirring pin F2 is composed of a tapering outer circumferential surface and a tip surface F3 formed at the tip. When viewed from the side, the inclination angle α between the outer circumferential surface of the stirring pin F2 and the central axis of rotation C may be set accordingly within a range of, say, 5° to 30°.

A spiral groove is engraved on the outer circumferential surface of the stirring pin F2. In the present embodiment, because the rotary tool F is rotated clockwise, the spiral groove is formed with a counterclockwise spiral. In other words, when tracing the spiral groove from the base end to the tip of the stirring pin F2, the spiral groove spirals in a counterclockwise direction as viewed from above the base end of the stirring pin F2.

Note that, if the rotary tool F is to be rotated counterclockwise, the spiral groove should preferably be formed with a clockwise spiral. In other words, when tracing the spiral groove from the base end to the tip of the stirring pin F2, the spiral groove spirals in a clockwise direction as viewed from above the base end of the stirring pin F2. The spiral groove is set in this way to allow metal that is plasticized and fluidized during friction stirring to be led by the spiral groove to the side of the tip of the stirring pin F2. In this way, it is possible to reduce the amount of metal that spills out from metal members being joined together (the jacket body 2 and the sealing body 3).

As shown in FIG. 3, when friction stirring is carried out by means of the rotary tool F, the rotary tool F is moved so that only the stirring pin F2 rotating clockwise is inserted into the sealing body 3, with the connection portion F1 kept away from the sealing body 3. In other words, friction stirring is carried out while keeping the base end portion of the stirring pin F2 exposed. A plasticized region W1 is formed as the friction stirred metal hardens along the movement locus of the rotary tool F. In the present embodiment, the stirring pin F2 is inserted into the sealing body 3 at a set starting position Sp, and the rotary tool F is moved along in a clockwise direction relative to the sealing body 3.

As shown in FIG. 4, in the main joining step, the rotary tool F is moved once around the sealing body 3 along the first butted section J1 with the central axis of rotation C of the rotary tool F tilted towards the central side (or peripheral side) of the jacket body 2 by a tilt angle γ with respect to a vertical plane so that only the stirring pin F2 is in contact with only the sealing body 3. Here, the tilt angle γ, which is the angle by which the central axis of rotation C of the rotary tool F tilts relative to a vertical plane, is set to be equal to the inclination angle α subtracted by the inclination angle β, where a is the angle between the outer circumferential surface of the stirring pin F2 and the central axis of rotation C and β is the angle of inclination of the step side surface 12b relative to a vertical plane. As a result, the step side surface 12b and the outer circumferential surface of the stirring pin F2 facing the step side surface 12b are parallel to one another. In other words, the direction in which the central axis of rotation C of the rotary tool F is tilted is determined by the difference between α and β. For example, if α>β, then the tilt angle γ becomes a positive value and the central axis of rotation C of the rotary tool F is tilted towards the central side of the jacket body 2. If, on the other hand, α<β, then the tilt angle γ becomes a negative value and the central axis of rotation C of the rotary tool F is tilted towards the peripheral side of the jacket body 2. If α=β, then the tilt angle γ becomes zero and the central axis of rotation C of the rotary tool F is kept upright and in parallel with a vertical plane. In the present embodiment, the depth of insertion of the stirring pin F2 is also set so that the tip surface F3 does not come into contact with the jacket body 2. The phrase “only the stirring pin F2 is in contact with only the sealing body 3” refers to a state where the outer surface of the stirring pin F2 is not in contact with the jacket body 2, but can include cases where the distance between the outer circumferential surface of the stirring pin F2 and the step side surface 12b is zero and also where the distance between the tip surface F3 of the stirring pin F2 and the step bottom surface 12a is zero.

When the outer circumferential surface of the stirring pin F2 is too far apart from the step side surface 12b, the joining strength of the first butted section J1 is reduced. The separation L between the step side surface 12b and the outer circumferential surface of the stirring pin F2 may be set in accordance with the materials used for the jacket body 2 and the sealing body 3. In cases where, as in the present embodiment, the outer circumferential surface of the stirring pin F2 avoids contact with the step side surface 12b and the tip surface F3 avoids contact with the step bottom surface 12a, the separation L should be set, for example, within the range 0≤L≤0.5 mm, and should preferably be set within the range 0≤L≤0.3 mm.

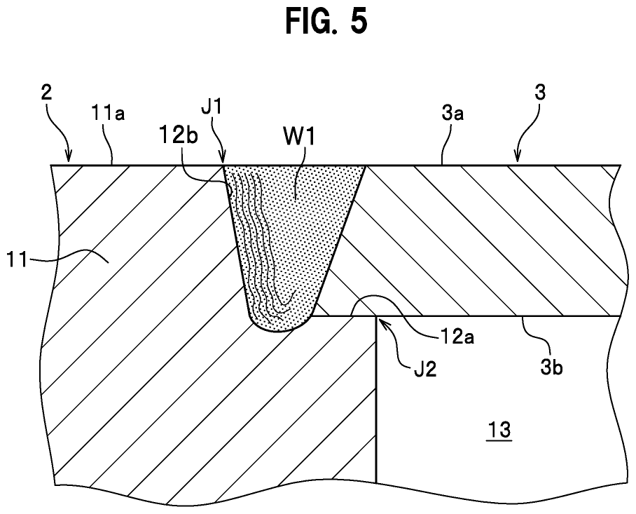

After the rotary tool F is moved once around the sealing body 3, the terminating point of the plasticized region W1 is overlapped with the starting point of the plasticized region W1. The rotary tool F may be raised gradually from the front surface 3a of the sealing body 3 for removal. FIG. 5 is a cross-sectional view of a joint after the main joining step according to the present embodiment. The plasticized region W1 that is formed extends beyond the second butted section J2 and into the jacket body 2.

According to the present embodiment of the method for manufacturing a liquid-cooling jacket described above, although the stirring pin F2 of the rotary tool F does not come into contact with the step side surface 12b, frictional heat generated between the sealing body 3 and the stirring pin F2 causes material at the first butted section J1, primarily the second aluminum alloy of the sealing body 3 to be stirred, plasticized, and fluidized, enabling the step side surface 12b and the side surface 3c of the sealing body 3 to be joined at the first butted section J1. Further, because friction stirring is carried out with only the stirring pin F2 in contact with only the sealing body 3, there is hardly any transfer of the first aluminum alloy from the jacket body 2 to the sealing body 3. In this way, friction stirring at the first butted section J1 occurs primarily in the second aluminum alloy of the sealing body 3, making it possible to suppress the reduction in joining strength.

Further, because the central axis of rotation C of the rotary tool F is tilted towards the central side (or peripheral side) of the jacket body 2 by a tilt angle γ relative to a vertical plane, contact between the stirring pin F2 and the jacket body 2 at the first butted section J1 can be avoided with ease. Also, in the present embodiment, γ, the tilt angle of the central axis of rotation C of the rotary tool F relative to a vertical plane, is made equal to α−β, where α is the inclination angle of the outer circumferential surface of the stirring pin F2 relative to the central axis of rotation C and β is the inclination angle of the step side surface 12b relative to a vertical plane. This way, it becomes possible to select optimum values for the inclination angles α and β. Also, by keeping the step side surface 12b and the outer circumferential surface of the stirring pin F2 facing the step side surface parallel to each other, it becomes possible to bring the outer circumferential surface of the stirring pin F2 and the step side surface 12b as close as possible to each other along the height direction while avoiding contact. For example, the inclination angle α is determined by the design concept of the rotary tool based on the technological field of friction stir welding, and the inclination angle β is determined by the design concept of metal casting based on a metal casting field such as die casting. In other words, both the inclination angles α and β have optimum values based on design concepts making it hard to make α=β in some cases. However, because there is freedom of choice regarding the inclination angles α and β with the present embodiment, optimum values may be selected for the inclination angles α and β.

Yet further, because friction stir welding is carried out by having only the stirring pin F2 come in contact with only the sealing body 3, it is possible to remove any imbalance between material resistance the stirring pin F2 receives on one side and on the other side across the central axis of rotation C of the stirring pin F2. In this way, material that undergoes plasticization and fluidization can be friction stirred in a well-balanced manner, making it possible to suppress the reduction in joining strength.

For the main joining step, the direction of rotation and direction of movement of the rotary tool F can be set as appropriate. In the present embodiment, the direction of rotation and direction of movement of the rotary tool F are set so that, within the plasticized region W1 formed along the movement locus of the rotary tool F, the side of the jacket body 2 becomes the shear side and the side of the sealing body 3 becomes the flow side. This way, the stirring effect of the stirring pin F2 around the first butted section J1 is heightened and a rise in temperature at the first butted section J1 can be expected, making it possible to more reliably join the step side surface 12b and the side surface 3c of the sealing body 3 at the first butted section J1.

Note that the shear side is the advancing side on which the speed of the circumference of the rotary tool relative to the joint is equal to the moving speed of the rotary tool added to the tangential speed on the circumference of the rotary tool. The flow side is the retreating side on which the speed of the rotary tool relative to the joint is reduced due to the rotation of the rotary tool opposing the direction of motion of the rotary tool.

Further, the first aluminum alloy of the jacket body 2 is a harder material than the second aluminum alloy of the sealing body 3. This way, durability of the liquid-cooling jacket 1 can be heightened. Also, it is preferable to make the first aluminum alloy of the jacket body 2 a cast aluminum alloy and the second aluminum alloy of the sealing body 3 a wrought aluminum alloy. By choosing for example an Al—Si—Cu cast aluminum alloy such as JIS H5302 Grade ADC12 for the first aluminum alloy, properties such as castability, strength, and machinability of the jacket body 2 can be enhanced. Also, by choosing for example a JIS A1000 series or A6000 series alloy for the second aluminum alloy, workability and thermal conductivity can be enhanced.

Yet further, in the present embodiment, even though the tip surface F3 of the stirring pin F2 is not inserted below the step bottom surface 12a, by making the plasticized region W1 reach the second butted section J2, joining strength can be enhanced.

### First Modification of the First Embodiment

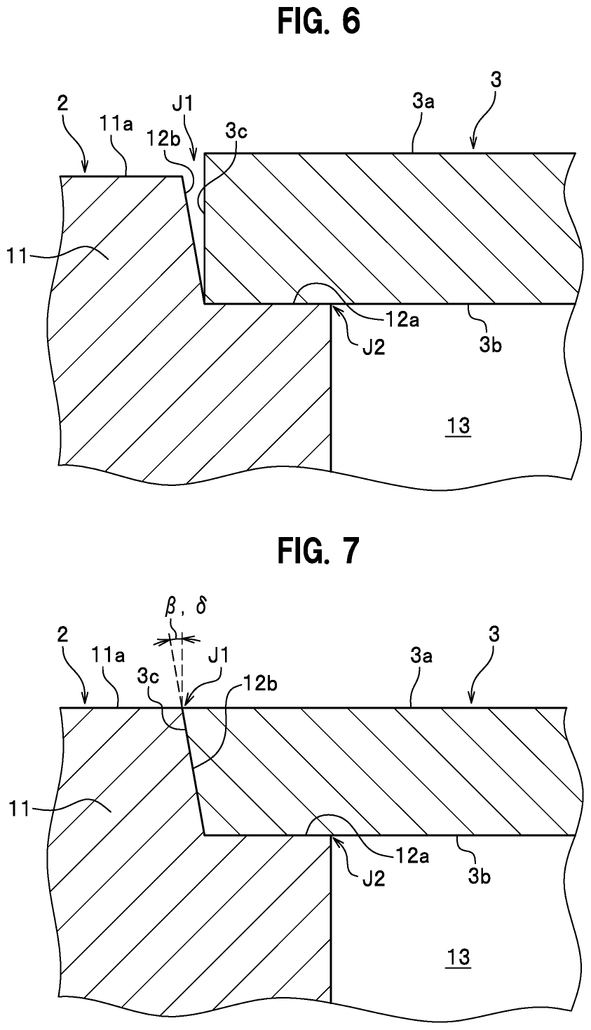

Next, description of a first modification of the first embodiment will be given. As shown in the first modification of FIG. 6, the plate thickness of the sealing body 3 can be made greater than the height dimension of the step side surface 12b. Although the gap formed in the first butted section J1 means that there is likelihood of the joint becoming deficient of metal, by using the first modification, it is possible to supplement the deficiency in metal.

### Second Modification of the First Embodiment

Next, description of a second modification of the first embodiment will be given. As shown in the second modification of FIG. 7, the side surface 3c of the sealing body 3 can be made to have a sloped surface. The side surface 3c slopes outwards from the back surface 3b to the front surface 3a. The inclination angle δ of the side surface 3c is made to be identical to the inclination angle β of the step side surface 12b relative to a vertical plane. This way, the step side surface 12b and the side surface 3c of the sealing body 3 make surface contact in the placing step. According to the second modification, since a gap is not generated in the first butted section J1, deficiency of metal at the joint can be supplemented.

### Second Embodiment

Next, description will be given of a manufacturing method for a liquid-cooling jacket according to the second embodiment of the present invention. The manufacturing method for a liquid-cooling jacket according to the second embodiment includes carrying out a preparation step, a placing step, and a main joining step. The preparation step and the placing step of the manufacturing method for a liquid-cooling jacket according to the second embodiment are the same as those of the first embodiment, and description is therefore omitted. Description will focus on areas where the second embodiment differs from the first embodiment.

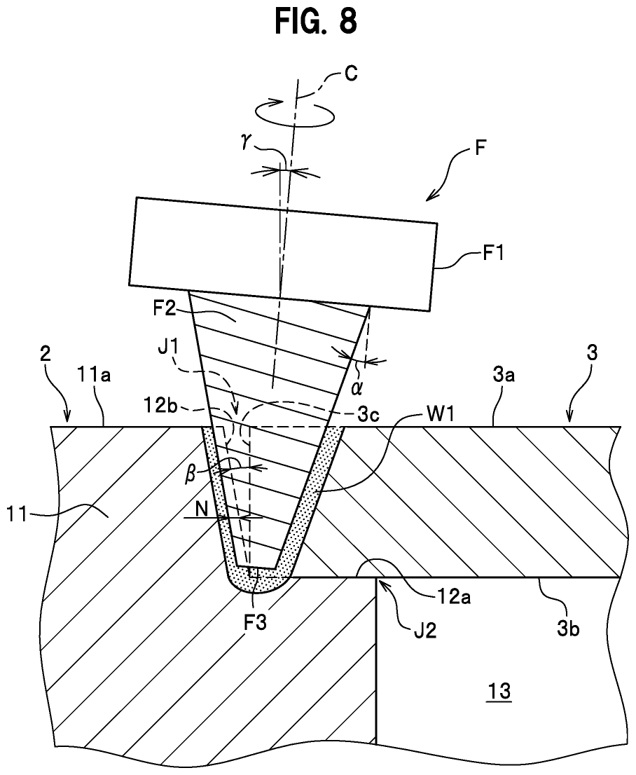

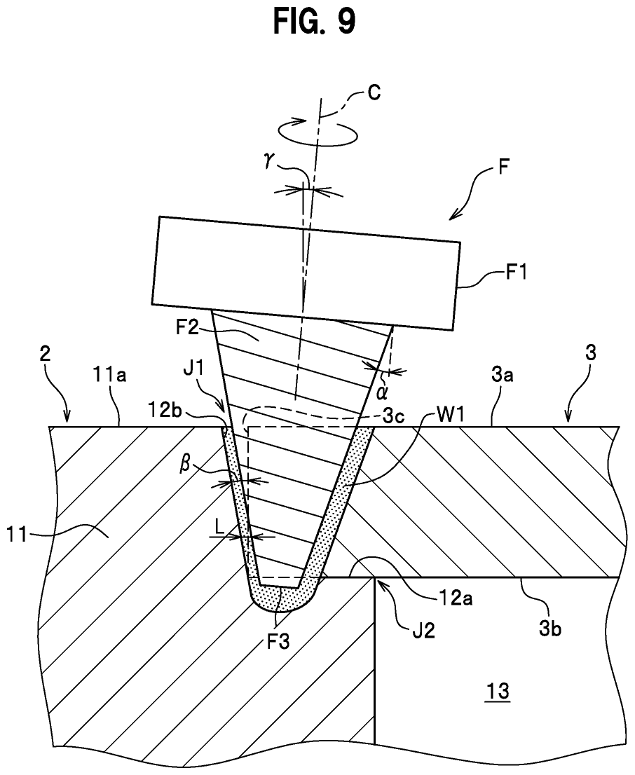

As shown in FIG. 8, the main joining step includes using friction stir welding to join the jacket body 2 and the sealing body 3 with the use of a rotary tool F. In the main joining step, when the stirring pin F2 is moved along the first butted section J1, friction stir welding is carried out with the outer circumferential surface of the stirring pin F2 in slight contact with the step side surface 12b and the tip surface F3 avoiding contact with the step bottom surface 12a.

The contact margin between the outer circumferential surface of the stirring pin F2 and the step side surface 12b is defined as an offset value N. In cases such as the present embodiment where the outer circumferential surface of the stirring pin F2 is in contact with the step side surface 12b and the tip surface F3 of the stirring pin F2 avoids contact with the step bottom surface 12a, the offset value N is set within the range 0<N≤0.5 mm, and should preferably be in the range 0<N≤0.25 mm.

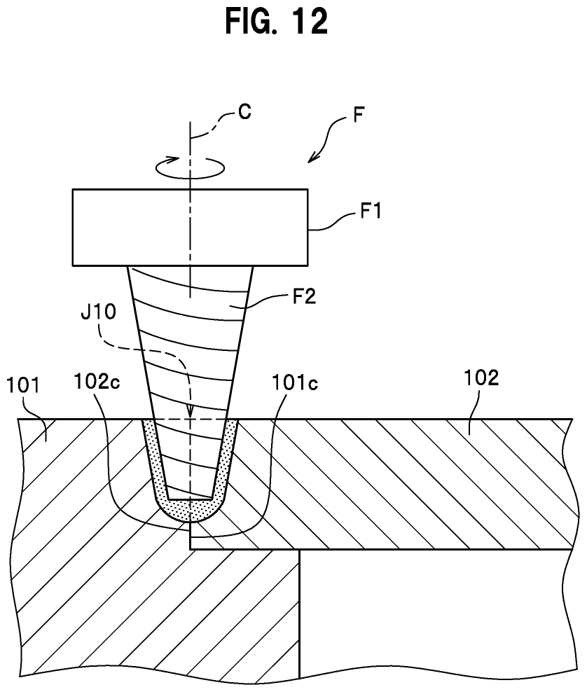

In the conventional method for manufacturing a liquid-cooling jacket as shown in FIG. 12, material resistance the stirring pin F2 receives on one side and on the other side across the central axis of rotation C differs greatly due to the difference in hardness of the jacket body 101 and the sealing body 102. This has meant that the material that undergoes plasticization and fluidization does not become stirred in a well-balanced manner, causing a reduction in joining strength. On the other hand, in the present embodiment, because the contact margin between the outer circumferential surface of the stirring pin F2 and the jacket body 2 is kept as small as possible, material resistance the stirring pin F2 receives from the jacket body 2 can be made as small as possible. Also, in the present embodiment, γ, the tilt angle of the central axis of rotation C of the rotary tool F relative to a vertical plane, is made equal to α−β, where α is the inclination angle of the outer circumferential surface of the stirring pin F2 relative to the central axis of rotation C and β is the inclination angle of the step side surface 12b relative to a vertical plane. This way, it becomes possible to select optimum values for the inclination angles α and β. Also, by keeping the step side surface 12b and the outer circumferential surface of the stirring pin F2 facing the step side surface parallel to each other, the contact margin between the outer circumferential surface of the stirring pin F2 and the step side surface 12b can be made uniform along the height direction. This way, material that undergoes plasticization and fluidization is stirred in a well-balanced manner, making it possible to suppress the reduction in joining strength.

Note that, in the second embodiment, the plate thickness of the sealing body 3 can be made larger and/or the side surface 3c of the sealing body 3 can be sloped, as in the first modification and second modification of the first embodiment.

### Third Embodiment

Next, description will be given of a manufacturing method for a liquid-cooling jacket according to a third embodiment of the present invention. The manufacturing method for a liquid-cooling jacket according to the third embodiment includes carrying out a preparation step, a placing step, and a main joining step. The preparation step and placing step of the manufacturing method for a liquid-cooling jacket according to the third embodiment are the same as those for the first embodiment, and description is therefore omitted. Description will focus on areas where the third embodiment differs from the first embodiment.

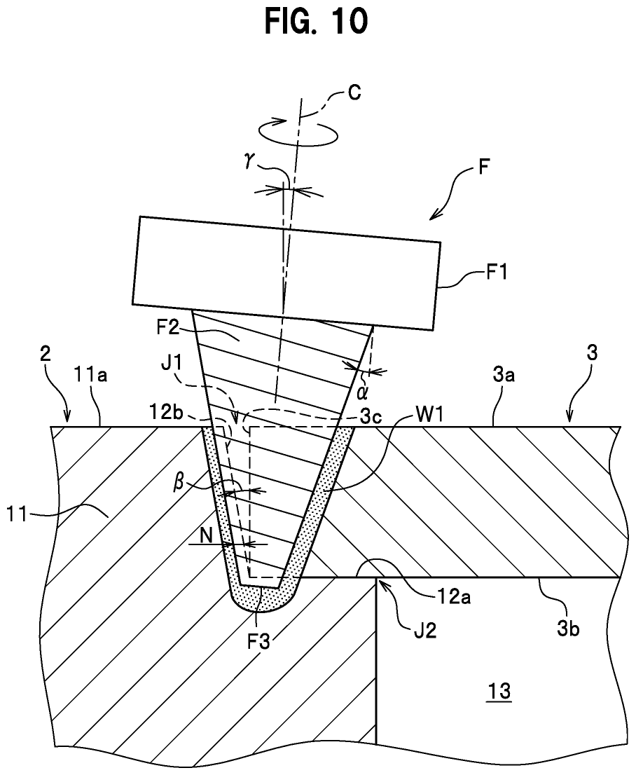

As shown in FIG. 9, the main joining step includes using friction stir welding to join the jacket body 2 and the sealing body 3 with the use of the rotary tool F. In the main joining step, when the stirring pin F2 is moved along the first butted section J1, friction stir welding is carried out by making the outer circumferential surface of the stirring pin F2 avoid contact with the step side surface 12b and by inserting the tip surface F3 below the step bottom surface 12a. Note that the phrase “inserting the tip surface F3 below the step bottom surface 12a” means that at least part of the tip surface F3 of the stirring pin F2 is disposed below the step bottom surface 12a, and includes cases where a part or whole of the tip surface F3 is in contact with the jacket body 2.

According to the manufacturing method for a liquid-cooling jacket of the present embodiment, even though the stirring pin F2 is not in contact with the step side surface 12b, frictional heat generated between the stirring pin F2 and the sealing body 3 causes material at the first butted section J1, primarily the second aluminum alloy of the sealing body 3, to be plasticized and fluidized, making it possible to join the step side surface 12b and the side surface 3c of the sealing body 3 at the first butted section. Also, because friction stirring at the first butted section J1 is carried out with only the stirring pin F2 in contact with only the sealing body 3, there is hardly any transfer of the first aluminum alloy from the jacket body 2 to the sealing body 3. In this way, it is primarily the second aluminum alloy of the sealing body 3 that is friction stirred at the first butted section J1, making it possible to suppress the reduction in joining strength.

Further, because the central axis of rotation C of the rotary tool F is tilted towards the central side (or peripheral side) of the jacket body 2 by a tilt angle γ relative to a vertical plane, contact between the stirring pin F2 and the step side surface 12b can be avoided with ease at the first butted section J1. Also, γ, the tilt angle of the central axis of rotation C of the rotary tool F relative to a vertical plane, is made equal to α−β, where α is the inclination angle of the outer circumferential surface of the stirring pin F2 relative to the central axis of rotation C and β is the inclination angle of the step side surface 12b relative to a vertical plane. This way, it becomes possible to select optimum values for the inclination angles α and β. Also, by keeping the step side surface 12b and the outer circumferential surface of the stirring pin F2 facing the step side surface parallel to each other, it becomes possible to bring the outer circumferential surface of the stirring pin F2 and the step side surface 12b as close as possible to each other along the height direction while avoiding contact.

Yet further, because friction stir welding is carried out by keeping the outer circumferential surface of the stirring pin F2 away from the step side surface 12b, it is possible to reduce the imbalance between material resistance the stirring pin F2 receives on one side and on the other side across the central axis of rotation C. In this way, material that undergoes plasticization and fluidization can be friction stirred in a well-balanced manner, making it possible to suppress the reduction in joining strength. In cases where, as in the present embodiment, the outer circumferential surface of the stirring pin F2 avoids contact with the step side surface 12b and the tip surface F3 is inserted below the step bottom surface 12a, the separation L between the step side surface 12b and the outer circumferential surface of the stirring pin F2 should, for example, be set within the range 0≤L≤0.5 mm, and should preferably be set within the range 0≤L≤0.3 mm.

Yet further, by inserting the tip surface F3 of the stirring pin F2 below the step bottom surface 12a, the lower part of the joint can be friction stirred more reliably. This way, joining strength can be enhanced. Also, the entire tip surface F3 of the stirring pin F2 is disposed more to the center side of the sealing body 3 from the side surface 3c of the sealing body 3. This way, the joining region at the second butted section J2 can be made large, making it possible to enhance joining strength.

Note that, in the third embodiment, the plate thickness of the sealing body 3 can be made larger and/or the side surface 3c of the sealing body 3 can be made to have a sloped surface as in the first modification and second modification of the first embodiment.

### Fourth Embodiment

A manufacturing method for a liquid-cooling jacket according to a fourth embodiment of the present invention will be described in detail. The manufacturing method for a liquid-cooling jacket according to the fourth embodiment includes carrying out a preparation step, a placing step, and a main joining step. The preparation step and placing step of the manufacturing method for a liquid-cooling jacket according to the fourth embodiment are the same as those for the first embodiment, and description is therefore omitted. Description will focus on areas where the fourth embodiment differs from the third embodiment.

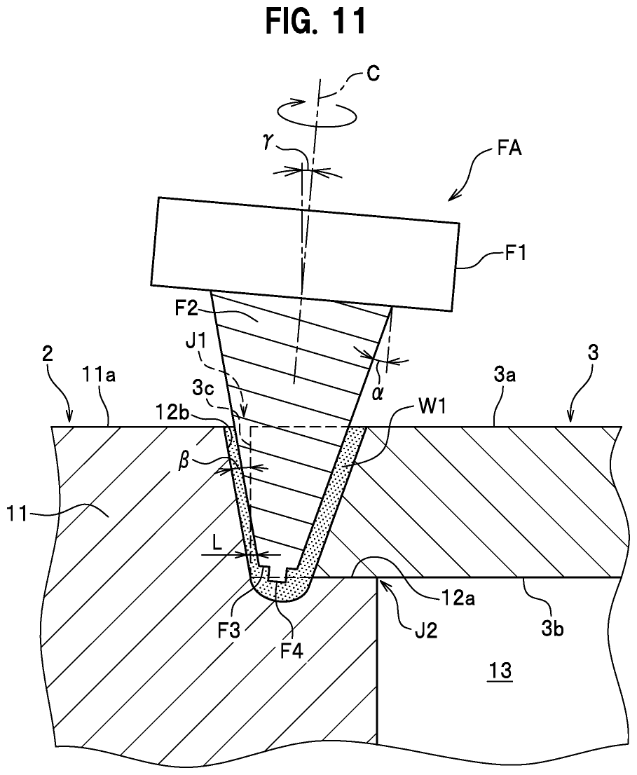

As shown in FIG. 10, the main joining step includes using friction stir welding to join the jacket body 2 and the sealing body 3 with the use of a rotary tool F. In the main joining step, friction stir welding is carried out by having the outer circumferential surface of the stirring pin F2 in slight contact with the step side surface 12b and by inserting the tip surface F3 below the step bottom surface 12a when the stirring pin F2 is moved along the first butted section J1. Note that the phrase “inserting the tip surface F3 below the step bottom surface 12a” refers to a state where at least a part of the tip surface F3 of the stirring pin F2 is below the step bottom surface 12a during friction stirring, and includes cases where a part or whole of the tip surface F3 is touching the jacket body 2.

The contact margin between the outer circumferential surface of the stirring pin F2 and the step side surface 12b is defined as an offset value N. In cases such as the present embodiment where the tip surface F3 of the stirring pin F2 is inserted below the step bottom surface 12a and the outer circumferential surface of the stirring pin F2 comes in contact with the step side surface 12b, the offset value N is set within the range 0<N≤1.0 mm, and should preferably be in the range 0<N≤0.85 mm, and more preferably should be in the range 0<N≤0.65 mm.

In the conventional manufacturing method for a liquid-cooling jacket shown in FIG. 12, because hardness differs between the jacket body 101 and the sealing body 102, material resistance the stirring pin F2 receives on one side and on the other side across the central axis of rotation C differs greatly. For this reason, material that undergoes plasticization and fluidization cannot be stirred in a well-balanced manner, causing joining strength to be reduced. On the other hand, in the present embodiment, because the contact margin between the outer circumferential surface of the stirring pin F2 and the jacket body 2 is made as small as possible, material resistance the stirring pin F2 receives from the jacket body 2 can be made small. Also, in the present embodiment, γ, the tilt angle of the central axis of rotation C of the rotary tool F relative to a vertical plane, is made equal to α−β, where α is the inclination angle of the outer circumferential surface of the stirring pin F2 with respect to the central axis of rotation C, and β is the inclination angle of the step side surface 12b relative to a vertical plane. This way, it becomes possible to select optimum values for the inclination angles α and β. Also, by keeping the step side surface 12b and the outer circumferential surface of the stirring pin F2 facing the step side surface parallel to each other, it becomes possible to make the contact margin between the outer circumferential surface of the stirring pin F2 and the step side surface 12b uniform along the height direction. This way, material that undergoes plasticization and fluidization can be stirred in a well-balanced manner in the present embodiment, making it possible to suppress the reduction in the strength of the joint.

Further, by inserting the tip surface F3 of the stirring pin F2 below the step bottom surface 12a, the lower part of the joint can be friction stirred more reliably. This way, the joining strength can be enhanced. In short, both the first butted section J1 and the second butted section J2 can be joined together firmly.

Note that, in the fourth embodiment, the plate thickness of the sealing body 3 can be made larger and/or the side surface 3c of the sealing body 3 can be made to have a sloped surface, as in the first modification and second modification of the first embodiment.

### Third Modification of the Third Embodiment

Next, description of a third modification of the third embodiment will be given. As shown in FIG. 11, the third modification of the third embodiment differs from the third embodiment in that the third modification uses a rotary tool FA. Description will focus on areas where the third modification differs from the third embodiment. Note that the third modification may be applied to the fourth embodiment as well.

The rotary tool FA used in the main joining step includes a connection portion F1 and a stirring pin F2. Also, the stirring pin F2 is configured with a tip surface F3 and a protrusion F4. The protrusion F4 protrudes down from the tip surface F3. There are no restrictions that apply to the shape of the protrusion F4, but in the present embodiment, the protrusion F4 is cylindrical in shape. The protrusion F4 and the tip surface F3 form a step profile.

In the main joining step of the third modification of the third embodiment, the tip of the rotary tool FA is inserted below the step bottom surface 12a (the side of the protrusion F4 is positioned at the step bottom surface 12a). This way, material that is friction stirred and undergoes plasticization and fluidization along the protrusion F4 and dragged upwards by the protrusion F4 is held down by the tip surface F3. This way, material around the protrusion F4 can be friction stirred more reliably and the oxide film at the second butted section J2 is torn with certainty. This way, joining strength at the second butted section J2 can be enhanced. Also, by arranging the rotary tool so that only the protrusion F4 is inserted below the second butted section J2 as in this modification, it is possible to make the width of the plasticized region W1 smaller compared to when the tip surface F3 is inserted below the second butted section J2. This way, it is possible to prevent material that undergoes plasticization and fluidization from spilling out into the recess 13 and to set a smaller width for the step bottom surface 12a.

Note that, although in the third modification of the third embodiment shown in FIG. 11, the protrusion F4 (the tip of the stirring pin F2) is arranged to be inserted below the second butted section J2, it is also possible to arrange the tip surface F3 to be inserted below the second butted section J2.

Embodiments of the present invention described above may undergo appropriate design changes or modification within the scope not departing from the gist of the present invention.

### REFERENCE SIGNS LIST

1 Liquid-cooling jacket
2 Jacket body
3 Sealing body
F, FA Rotary tool
F1 Connection portion
F2 Stirring pin
F3 Tip surface
F4 Protrusion
J1 First butted section
J2 Second butted section
W1 Plasticized region

What is claimed is:

1. A method for manufacturing a liquid-cooling jacket comprising a jacket body, which includes a bottom portion and a peripheral wall portion that stands on the periphery of the bottom portion, and a sealing body, which seals an opening of the jacket body, wherein the jacket body and the sealing body are joined using a rotary tool with a stirring pin, the method comprising:
a preparation step which forms, along an inner circumferential edge of the peripheral wall portion, a stepped portion comprising a step bottom surface and a step side surface rising and sloping backwards from the step bottom surface to the opening of the jacket body;
a placing step where the sealing body is placed on the jacket body to allow the step side surface and a sealing body side surface to butt each other to form a first butted section and a part of a sealing body back surface to be overlaid on the step bottom surface to form a second butted section; and
a main joining step where friction stir welding is performed by moving the rotary tool once around the sealing body along the first butted section while only the stirring pin of the rotating rotary tool is in contact with only the sealing body,
wherein
the jacket body is formed from a first aluminum alloy and the sealing body is formed from a second aluminum alloy,
the first aluminum alloy is a harder type of material than the second aluminum alloy,
the stirring pin has a tip and an inclined outer circumferential surface that tapers down to the tip, and
during the main joining step, a central axis of rotation of the rotary tool is tilted either towards a central side or a peripheral side of the jacket body or is kept upright so that the central axis of rotation of the rotary tool is parallel to a vertical plane, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

2. A method for manufacturing a liquid-cooling jacket comprising a jacket body, which includes a bottom portion and a peripheral wall portion that stands on the periphery of the bottom portion, and a sealing body, which seals an opening of the jacket body, wherein the jacket body and the sealing body are joined using a rotary tool with a stirring pin, the method comprising:
a preparation step which forms, along an inner circumferential edge of the peripheral wall portion, a stepped portion comprising a step bottom surface and a step side surface rising and sloping backwards from the step bottom surface to the opening of the jacket body;
a placing step where the sealing body is placed on the jacket body to allow the step side surface and a sealing body side surface to butt each other to form a first butted section and a part of a sealing body back surface to be overlaid on the step bottom surface to form a second butted section; and
a main joining step where friction stir welding is performed by moving the rotary tool once around the sealing body along the first butted section while only the stirring pin of the rotating rotary tool is made to be in contact with the sealing body and only the stirring pin is made to be in slight contact with the step side surface of the jacket body,
wherein
the jacket body is formed from a first aluminum alloy and the sealing body is formed from a second aluminum alloy,
the first aluminum alloy is a harder type of material than the second aluminum alloy,
the stirring pin has a tip and an inclined outer circumferential surface that tapers down to the tip, and
during the main joining step, a central axis of rotation of the rotary tool is tilted either towards a central side or a peripheral side of the jacket body or is kept upright so that the central axis of rotation of the rotary tool is parallel to a vertical plane, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

3. A method for manufacturing a liquid-cooling jacket comprising a jacket body, which includes a bottom portion and a peripheral wall portion that stands on the periphery of the bottom portion, and a sealing body, which seals an opening of the jacket body, wherein the jacket body and the sealing body are joined using a rotary tool with a stirring pin, the method comprising:
a preparation step which forms, along an inner circumferential edge of the peripheral wall portion, a stepped portion comprising a step bottom surface and a step side surface rising and sloping backwards from the step bottom surface to the opening of the jacket body;
a placing step where the sealing body is placed on the jacket body to allow the step side surface and a sealing body side surface to butt each other to form a first butted section and a part of a sealing body back surface to be overlaid on the step bottom surface to form a second butted section; and
a main joining step,
wherein
the jacket body is formed from a first aluminum alloy and the sealing body is formed from a second aluminum alloy,
the first aluminum alloy is a harder type of material than the second aluminum alloy,
the stirring pin has a flat tip surface and an inclined outer circumferential surface that tapers down to a tip of the stirring pin,
during the main joining step, friction stir welding is performed by moving the rotary tool once around the sealing body along the first butted section while the tip of the stirring pin of the rotating rotary tool is inserted below the step bottom surface and the outer circumferential surface of the stirring pin and the step side surface are kept apart, and
during the main joining step, a central axis of rotation of the rotary tool is tilted either towards a central side or a peripheral side of the jacket body or is kept upright so that the central axis of rotation of the rotary tool is parallel to a vertical plane, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

4. A method for manufacturing a liquid-cooling jacket comprising a jacket body, which includes a bottom portion and a peripheral wall portion that stands on the periphery of the bottom portion, and a sealing body, which seals an opening of the jacket body, wherein the jacket body and the sealing body are joined using a rotary tool with a stirring pin, the method comprising:
a preparation step which forms, along an inner circumferential edge of the peripheral wall portion, a stepped portion comprising a step bottom surface and a step side surface rising and sloping backwards from the step bottom surface to the opening of the jacket body;
a placing step where the sealing body is placed on the jacket body to allow the step side surface and a sealing body side surface to butt each other to form a first butted section and a part of a sealing body back surface to be overlaid on the step bottom surface to form a second butted section; and
a main joining step,
wherein
the jacket body is formed from a first aluminum alloy and the sealing body is formed from a second aluminum alloy,
the first aluminum alloy is a harder type of material than the second aluminum alloy,
the stirring pin has a flat tip surface and an inclined outer circumferential surface that tapers down to a tip of the stirring pin,
during the main joining step, friction stir welding is performed by moving the rotary tool once around the sealing body along the first butted section while the tip of the stirring pin of the rotating rotary tool is inserted below the step bottom surface and the outer circumferential surface of the stirring pin is made to be in slight contact with the step side surface, and
during the main joining step, a central axis of rotation of the rotary tool is tilted either towards a central side or a peripheral side of the jacket body or is kept upright so that the central axis of rotation of the rotary tool is parallel to a vertical plane, and friction stir welding is performed under a condition in which γ=α−β, where γ is a tilt angle of the central axis of rotation of the rotary tool with respect to a vertical plane, β is an inclination angle of the step side surface with respect to a vertical plane, and α is an inclination angle of the outer circumferential surface of the stirring pin with respect to the central axis of rotation.

5. The method for manufacturing a liquid-cooling jacket according to claim 4, wherein a plate thickness of the sealing body is greater than the height of the step side surface.

6. The method for manufacturing a liquid-cooling jacket according to claim 4,
wherein
the sealing body side surface is formed with an inclined surface, and
the placing step further comprising bringing the step side surface and the inclined surface of the sealing body side surface in surface contact with each other.

7. The method for manufacturing a liquid-cooling jacket according to claim 4, wherein the sealing body is formed from a wrought aluminum alloy and the jacket body is formed from a cast aluminum alloy.

8. The method for manufacturing a liquid-cooling jacket according to claim 4,
wherein
the rotary tool is rotated clockwise when a spiral groove is engraved on an outer circumferential surface of the rotary tool so that the spiral groove runs in a counterclockwise direction starting from a base end to a tip of the rotary tool, and
the rotary tool is rotated counterclockwise when a spiral groove is engraved on the outer circumferential surface of the rotary tool in a clockwise direction starting from a base end to a tip of the rotary tool.

9. The method for manufacturing a liquid-cooling jacket according to claim 4, wherein
a direction of rotation and a direction of forward movement of the rotary tool are set so that the rotary tool has a plasticized region formed along a movement locus of the rotary tool, the plasticized region having a jacket body side for a shear side and a sealing body side for a flow side.
